(19) United States
(12) Patent Application Publication
(10) Pub. No.: US 2019/0334663 A1
(43) Pub. Date: Oct. 31, 2019

(54) TRANSMISSION TOGGLE UPLINK COMPENSATION

(71) Applicant: Intel IP Corporation, Santa Clara, CA (US)

(72) Inventors: Rishav Dev, Bangalore (IN); Saikat Saha, Bangalore (IN)

(21) Appl. No.: 15/738,993

(22) PCT Filed: Jun. 22, 2016
(86) PCT No.: PCT/US16/38662

§ 371 Date: Mar. 23, 2018

(30) Foreign Application Priority Data
Jun. 26, 2015 (IN) 3218/CHE/2015

(51) Int. Cl. H04L 1/18

(52) U.S. Cl. CPC H04L 1/1887; H04L 1/1874; H04L 1/1812

(57) ABSTRACT

A retransmission method and a communication device configured to perform a retransmission method. The communication device can be configured to perform Dual-SIM-Dual-active operations using transmission toggling between wireless communication networks. The communication device can determine a transmission schedule of a first communication protocol. The communication device can also determine a retransmission threshold (e.g., maximum hybrid automatic repeat request retransmission threshold) of a second communication protocol. The communication device can determine a transmission count of the second communication protocol based on the transmission schedule. A scheduling request (SR)/buffer status report (BSR) can be initiated based on a comparison of the transmission count and the retransmission threshold. The SR/BSR can be initiated without a status PDU having been received. The communication device can prioritize lost data and retransmit the lost data using a same Radio Link Control (RLC) sequence number and a new uplink grant irrespective of the RLC mode.

### BACKGROUND

### Field

Aspects described herein generally relate to multiple subscriber identity module (SIM) wireless communications, including transmission toggling between two or more wireless communication networks.

### BRIEF DESCRIPTION OF THE DRAWINGS/FIGURES

The accompanying drawings, which are incorporated herein and form a part of the specification, illustrate the aspects of the present disclosure and, together with the description, further serve to explain the principles of the aspects and to enable a person skilled in the pertinent art to make and use the aspects.

FIG. 1 illustrates an example network environment.

FIG. 2 illustrates a base station according to an exemplary aspect of the present disclosure.

FIG. 3 illustrates a mobile device according to an exemplary aspect of the present disclosure.

FIG. 4 illustrates a communication procedure according to an exemplary aspect of the present disclosure.

FIG. 5 illustrates a scheduling request procedure according to an exemplary aspect of the present disclosure.

FIG. 6 illustrates a retransmission procedure according to an exemplary aspect of the present disclosure.

The exemplary aspects of the present disclosure will be described with reference to the accompanying drawings. The drawing in which an element first appears is typically indicated by the leftmost digit(s) in the corresponding reference number.

### DETAILED DESCRIPTION

In the following description, numerous specific details are set forth in order to provide a thorough understanding of the aspects of the present disclosure. However, it will be apparent to those skilled in the art that the aspects, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring aspects of the disclosure.

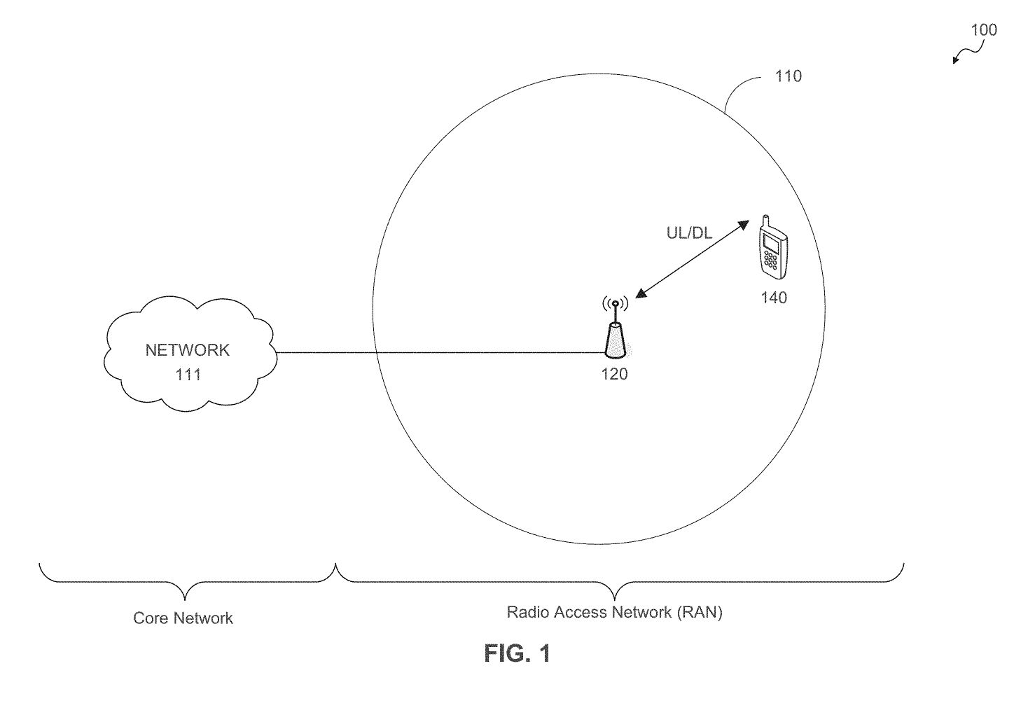

FIG. 1 illustrates an example communication environment 100 that includes a radio access network (RAN) and a core network. The RAN includes one or more base stations 120 and one or more mobile devices 140. The core network includes a backhaul communication network 111. In an exemplary aspect, the backhaul communication network 111 can include one or more well-known communication components—such as one or more network switches, one or more network gateways, and/or one or more servers. The backhaul communication network 111 can include one or more devices and/or components configured to exchange data with one or more other devices and/or components via one or more wired and/or wireless communications protocols. In exemplary aspects, the base stations 120 communicate with one or more service providers and/or one or more other base stations 120 via the backhaul communication network 111. In an exemplary aspect, the backhaul communication network is an internet protocol (IP) backhaul network.

The number of base stations 120, mobile devices 140, and/or networks 111 are not limited to the exemplary quantities illustrated in FIG. 1, and the communication environment 100 can include any number of the various components as would be understood by one of ordinary skill in the relevant art(s).

In an exemplary aspect, the base station 120 and mobile device 140 each include processor circuitry that is configured to communicate via one or more wireless technologies. The mobile device 140 can be further configured to support co-existing wireless communications with the base station 120, and/or co-existing wireless communications with the base station 120 and one or more other base stations, where the base station 120 supports one or more wireless communications and the other base station supports one or more other wireless communications. In an exemplary aspect, the mobile device 140 can include two or more subscriber identity modules (SIMs) configured for Dual SIM-Dual active (DSDA) operation. For example, a first SIM can support wireless communications (e.g., 2G) on a first wireless network and a second SIM card can support wireless communications (e.g., 2G/3G/4G) on a second wireless network. In an exemplary aspect, the wireless communications on the second wireless network include LTE communications. The first and second networks can be supported by a single base station 120 or multiple base stations.

The mobile device 140 and the base station 120 can each include a transceiver configured to transmit and/or receive wireless communications via one or more wireless technologies within the communication environment 100. In operation, the mobile device 140 can be configured to communicate with the base station 120 in a serving cell or sector 110 of the communication environment 100. For example, the mobile device 140 receives signals on one or more downlink (DL) channels from the base station 120, and transmits signals to the base station 120 on one or more respective uplink (UL) channels.

Examples of the mobile device 140 include (but are not limited to) a mobile computing device—such as a laptop computer, a tablet computer, a mobile telephone or smartphone, a “phablet,” a personal digital assistant (PDA), and mobile media player; and a wearable computing device—such as a computerized wrist watch or “smart” watch, and computerized eyeglasses. In some aspects of the present disclosure, the mobile device 140 may be a stationary device, including, for example, a stationary computing device—such as a personal computer (PC), a desktop computer, a computerized kiosk, and an automotive/aeronautical/maritime in-dash computer terminal.

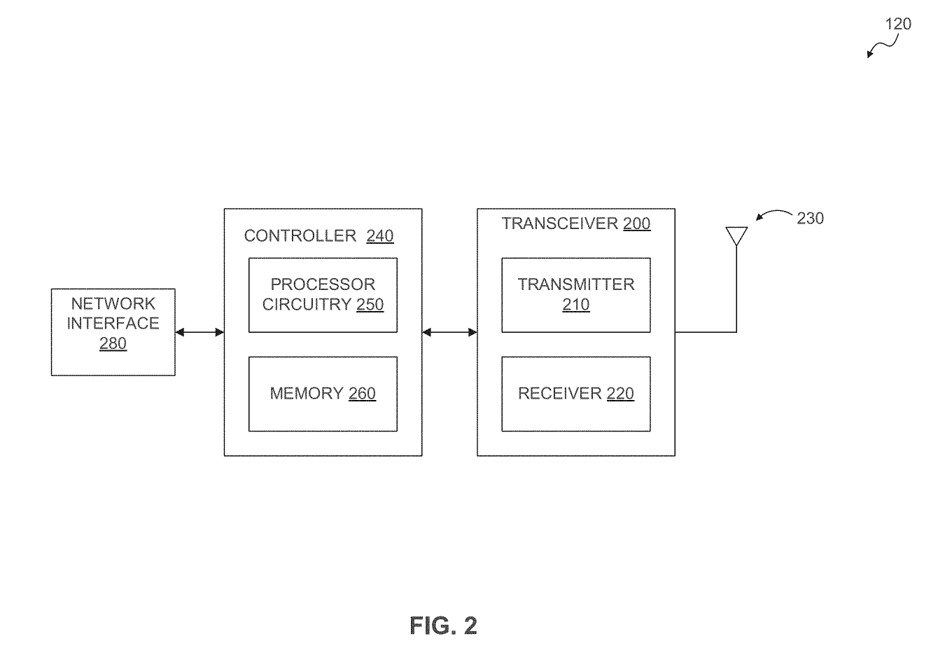

FIG. 2 illustrates the base station 120 according to an exemplary aspect of the present disclosure. For example, the base station 120 can include a transceiver 200 and a network interface 280, each communicatively coupled to controller 240.

The transceiver 200 includes processor circuitry that is configured to transmit and/or receive wireless communications via one or more wireless technologies within the communication environment 100. For example, the transceiver 200 can include one or more transmitters 210 and one or more receivers 220 that configured to transmit and receive wireless communications, respectively, via one or more antennas 230. Those skilled in the relevant art(s) will recognize that the transceiver 200 can also include (but is not limited to) a digital signal processer (DSP), modulator and/or demodulator, a digital-to-analog converter (DAC) and/or an analog-to-digital converter (ADC), and/or a frequency converter (including mixers, local oscillators, and filters) to provide some examples. Further, those skilled in the relevant art(s) will recognize that the antenna 230 may include an integer array of antennas, and that the antenna 230 may be capable of both transmitting and receiving wireless communication signals. For example, the base station 120 can be configured for wireless communication utilizing a Multiple-input Multiple-output (MIMO) configuration.

In an exemplary aspect, the transceiver 200 is configured for wireless communications conforming to, for example, the Long-Term Evolution (LTE) protocol. In this example, the transceiver 200 can be referred to as LTE transceiver 200. Those skilled in the relevant art(s) will understand that the transceiver 200 is not limited to LTE communications, and can be configured for communications that conform to one or more other protocols.

The network interface 280 includes processor circuitry that is configured to transmit and/or receive communications via one or more wired technologies to/from the backhaul communication network 111. Those skilled in the relevant art(s) will recognize that the network interface 280 can also include (but is not limited to) a digital signal processer (DSP), modulator and/or demodulator, a digital-to-analog converter (DAC) and/or an analog-to-digital converter (ADC), and/or a frequency converter (including mixers, local oscillators, and filters) to provide some examples. Further, those skilled in the relevant art(s) will understand that the network interface 280 is not limited to wired communication technologies and can be configured for communications that conform to one or more well-known wireless technologies in addition to, or alternatively to, one or more well-known wired technologies.

The controller 240 can include processor circuitry 250 that is configured to carry out instructions to perform arithmetical, logical, and/or input/output (I/O) operations of the base station 120 and/or one or more components of the base station 120. The processor circuitry 250 can be configured control the operation of the transceiver 200—including, for example, transmitting and/or receiving of wireless communications via the transceiver 200, and/or perform one or more baseband processing functions (e.g., media access control (MAC), encoding/decoding, modulation/demodulation, data symbol mapping, error correction, etc.).

The controller 240 can further include a memory 260 that stores data and/or instructions, where when the instructions are executed by the processor circuitry 250, controls the processor circuitry 250 to perform the functions described herein. The memory 260 can be any well-known volatile and/or non-volatile memory, including, for example, read-only memory (ROM), random access memory (RAM), flash memory, a magnetic storage media, an optical disc, erasable programmable read only memory (EPROM), and programmable read only memory (PROM). The memory 260 can be non-removable, removable, or a combination of both.

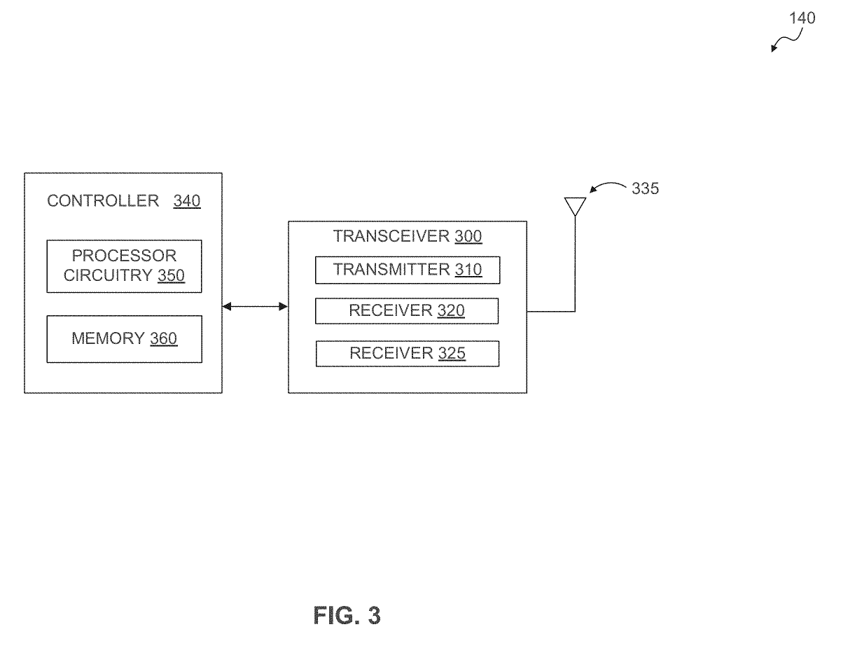

FIG. 3 illustrates the mobile device 140 according to an exemplary aspect of the present disclosure. The mobile device 140 can include controller 340 communicatively coupled to one or more transceivers 300 configured to transmit and/or receive wireless communications via one or more wireless technologies within the communication environment 100.

The transceiver 300 can include processor circuitry that is configured for transmitting and/or receiving wireless communications conforming to one or more wireless protocols. For example, the transceiver 300 can include a transmitter 310 and two receivers—receiver 320 and receiver 325—that are configured for transmitting and receiving wireless communications, respectively, via one or more antennas 335.

In exemplary aspects, the transceiver 300 can include (but is not limited to) a digital signal processer (DSP), modulator and/or demodulator, a digital-to-analog converter (DAC) and/or an analog-to-digital converter (ADC), and/or a frequency converter (including mixers, local oscillators, and filters) that can be utilized in transmitting and/or receiving of wireless communications. Further, those skilled in the relevant art(s) will recognize that antenna 335 may include an integer array of antennas, and that the antennas may be capable of both transmitting and receiving wireless communication signals.

The controller 340 can include processor circuitry 340 that is configured to control the overall operation of the mobile device 140, such as the operation of the transceiver 300—including, for example, transmitting and/or receiving of wireless communications via the transceiver 300, and/or perform one or more baseband processing functions (e.g., media access control (MAC), encoding/decoding, modulation/demodulation, data symbol mapping, error correction, etc.); the running of one or more applications and/or operating systems; power management (e.g., battery control and monitoring); display settings; volume control; and/or user interactions via one or more user interfaces (e.g., keyboard, touchscreen display, microphone, speaker, etc.).

The controller 340 can further include a memory 360 that stores data and/or instructions, where when the instructions are executed by the processor circuitry 350, controls the processor circuitry 350 to perform the functions described herein. The memory 360 can be any well-known volatile and/or non-volatile memory, and can be non-removable, removable, or a combination of both.

In an exemplary aspect, the mobile device 140 can include two or more subscriber identity modules (SIMs) configured for Dual SIM-Dual active (DSDA) operation. For example, the receiver 320 can be associated with a first SIM card that support wireless communications (e.g., 2G) on a first wireless network and the receiver 325 can be associated with a second SIM card that support wireless communications (e.g., 2G/3G/4G) on a second wireless network. In this example, the transmitter 310 is configured to support wireless communications on both the first and second wireless networks, and configured to perform transmission toggling (TxT) based on one or more transmission schedules associated with the first and/or second wireless networks. In an exemplary aspect, the scheduling of uplink communications can include toggling of transmissions (i.e., TxT) between the wireless networks associated with the mobile device 140 to multiplex two or more transmissions (e.g., a first uplink transmission associated with the first SIM card and a second uplink transmission associated with the second SIM card) in the time and/or frequency domains.

In operation, the controller 340 can be configured to schedule uplink communications for the first and second wireless networks to perform transmission toggling (TxT). The transmitter 310 can then be configured to transmit the uplink communications based on the transmission schedule(s).

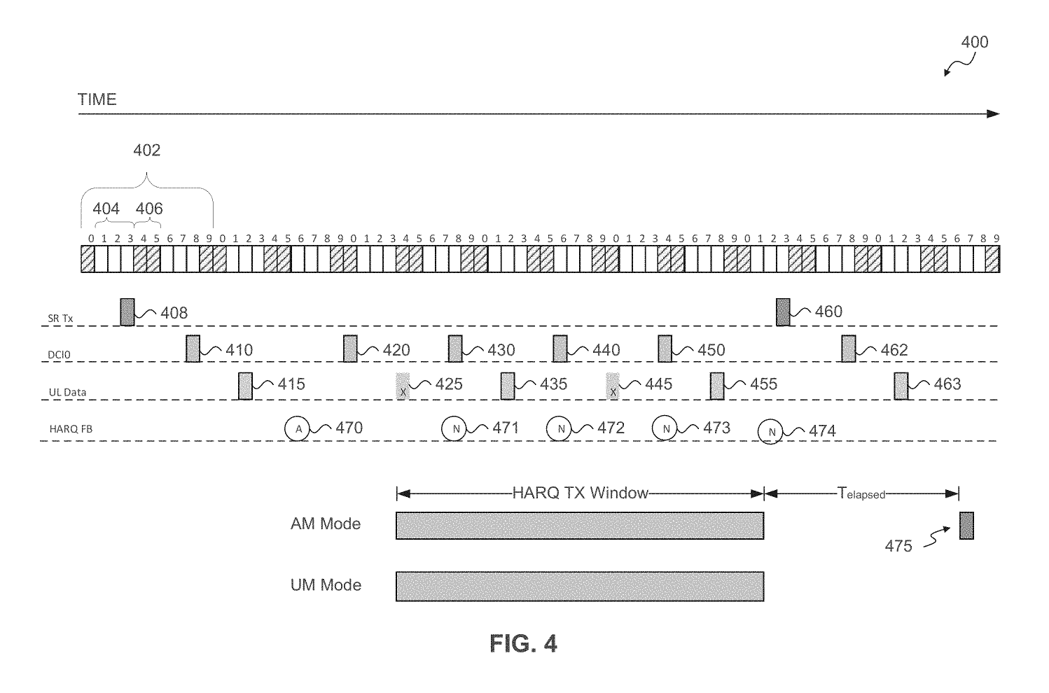

FIG. 4 illustrates an exemplary hybrid automatic repeat request (HARQ) procedure 400 according to an aspect of the present disclosure.

In an exemplary aspect, a radio frame 402 can include ten subframes. The radio frame 402 can have a duration of 10 ms, where each subframe is 1 ms. As illustrated in FIG. 4, the radio frame 402 includes the subframes 0-9.

During a Dual SIM-Dual active (DSDA) operation, some subframes (e.g., 406) will be used for transmission associated with a first wireless network (e.g., 2G), and other subframes (e.g., 404) will be used for transmission associated with a second wireless network (e.g., 2G/3G/4G, LTE, etc.). In operation, the controller 340 can control the transmitter 310 to toggle transmission between the two wireless networks. In this example, transmissions associated with the first wireless network are indicated by cross-hatched subframes and transmissions associated with the second wireless network are indicated by solid, empty subframes.

The mobile device 140 can be configured to perform a hybrid automatic repeat request (HARQ) procedure to transmit one or more uplink transmissions to the base station 120. The mobile device 140 can also be configured to generate a schedule request and provide the schedule request to the base station 120. The schedule request includes a request by the mobile device 140 to transmit uplink transmission(s) to the base station 120. Based on the schedule request, the base station 120 generates and provides one or more transmission grants to the mobile device 140 that identify uplink resources allocated to the mobile device 140 by the base station 120. The mobile device 140 transmits data in an uplink transmission to the base station 120 during the uplink resources identified in the transmission grant(s). The HARQ procedure can use one or more feedback mechanisms, including a HARQ feedback process to identify successful or unsuccessful uplink transmission. For example, the base station 120 can be configured to generate an acknowledgement (ACK) that is transmitted to the mobile device 140 to identify that the corresponding uplink transmission was successfully received by the base station 120. If the uplink transmission was not successfully received, the base station 120 can generate and provide a Non-Acknowledgement (NACK) to the mobile device 140.

In cases where a NACK is received, the mobile device 140 can be configured to perform a retransmission procedure (e.g., HARQ procedure) to retransmit the uplink transmission to the base station 120. The base station 120 can define parameters for the retransmission procedure that limit the number of retransmission attempts in response to unsuccessful uplink transmissions (e.g., when a NACK is received). For example, the retransmission procedure can define a maximum HARQ retransmission threshold (maxHARQTx) that sets the maximum number of retransmission attempts before one or more higher-layer retransmission procedures (e.g., a Radio Link Control (RLC) retransmission procedure) are performed. In cases where the higher-layer retransmission procedure(s) are unsuccessful, one or more Transmission Control Protocol (TCP) level retransmissions can be performed. The maximum HARQ retransmission threshold can be, for example, two, four, six, eight, or another value as would be understood by one of ordinary skill in the relevant arts. In an exemplary aspect, the maximum HARQ retransmission threshold is four, which is illustrated in FIG. 4 and discussed in detail below.

With reference to FIG. 4, the mobile device 140 can initiate a schedule request transmission 408 and transmitting the schedule request transmission 408 to the base station 120. In operation, the controller 340 generates a schedule request transmission 408 and transmits the schedule request transmission 408 via the transmitter 310 to the base station 120. In an exemplary aspect, the schedule request transmission 408 is associated with the second wireless network.

The base station 120 generates a transmission grant 410 which is communicated to the mobile device 140 in a downlink transmission. The transmission grant 410 authorizes the mobile device 140 to transmit an uplink transmission to the base station 120. In an exemplary aspect, the transmission grant 410 authorizes the mobile device 140 to transmit an uplink transmission, for example, 4 ms after the receipt of the transmission grant 410. Here, the uplink transmission data 415 is transmitted to the base station 120 during the subframe 2 of a second radio frame 402. In an exemplary aspect, the uplink transmission data 415 can include a buffer status report (BSR) that indicates the data queue load at the mobile device 140. That is, the BSR procedure can be used to provide the base station 120 with information about the data available for transmission in the uplink buffers of the mobile device 140. As illustrated in FIG. 4, the uplink transmission data 415 is successfully transmitted by the transmitter 310 using the second wireless network because the uplink transmission is performed during a subframe allocated to second network transmissions by the transmission schedule as indicated by solid, empty subframe 2. In response to the uplink transmission data 415 being successfully received by the base station 120, the base station 120 can generate an acknowledgement (ACK) that is then transmitted to the mobile device 140 in a downlink transmission. In this example, the ACK 470 is received by the mobile device 140 and acknowledges the successfully reception of the uplink transmission data 415 by the base station 120. In this example, because the uplink transmission was successfully received and acknowledged by the base station 120, the mobile device 140 does not perform a retransmission procedure for the uplink transmission. In cases where the uplink transmission data 415 includes a BSR, the mobile device 140 can expect one or more subsequent uplink grants from the base station 120.

In cases where the uplink data is not successfully transmitted to the base station 120 by the mobile device 140, or the uplink data is successfully transmitted but not successfully received by the base station 120, the base station 120 can generate a Non-Acknowledgement (NACK) to indicate the unsuccessful transmission. In some cases, an ACK generated by the base station 120 may nonetheless be perceived by the mobile device 140 a NACK. In these examples, the mobile device 140 can perform a hybrid automatic repeat request (HARQ) level retransmission procedure.

For example, in response to transmission grant 420, the mobile device 140 can be configured to generate and transmit uplink transmission data 425 to the base station 120. However, during the allocated subframe, the transmission schedule is occupied by the first wireless network (as indicated by the cross-hatched subframe 4) due to the transmission toggling of the mobile device 140. As a result, the mobile device 140 is unable to transmit the uplink transmission data 425 to the base station 120 during the allocated resource designated by the transmission grant 420. Because the base station 120 did not receive the uplink transmission data 425 during the resource allocated to the mobile device 140 by the base station 120 and specified in the transmission grant 420, the base station 120 can generate and transmits a NACK (e.g., NACK 471) to the mobile device 140. In this example, the mobile device 140 will understand and expect a NACK to be transmitted by the base station 120 as the mobile device 140 is aware that it was unable to transmit the uplink transmission data 425. That is, the mobile device 140 can determine an implicit NACK based on the mobile device's 140 inability to transmit the uplink transmission data 425 (e.g., due to the transmission schedule of the first wireless network).

In operation, the base station 120 can be configured to generate and transmit a transmission grant 430 to the mobile device 140 in a downlink transmission based on the unsuccessful uplink transmission. The transmission grant 430 can be communicated to the mobile device 140 in the same, or a separate, transmission of the NACK. The transmission grant 430 can include allocation and/or modulation information that may indicate allocation and/or modulation changes. In an exemplary aspect, the inclusion of allocation and/or modulation information can be used in adaptive HARQ retransmission procedures.

In response to transmission grant 430, the mobile device 140 can be configured to retransmit the uplink transmission to the base station 120. For example, the mobile device 140 can transmit uplink transmission data 435 to the base station 120. In this example, the mobile device 140 has resources available to the second wireless network (as indicated by the solid, empty subframe 2) and transmits the uplink transmission data 435 to the base station 120. Again, the base station 120 is configured to acknowledge whether the transmission was successfully received by generating a corresponding ACK or NACK. In this example, the uplink transmission data 435 was not successfully received as evidenced by the NACK 472 generated and transmitted to the mobile device 140. The unsuccessful transmission can be caused by, for example, interference that impacts or otherwise corrupts the transmission.

Because the uplink transmission data 435 was not successfully received, the mobile device 140 can perform another retransmission attempt in response to another transmission grant 440. In this example, the allocated subframe resource is occupied by the first wireless network (as indicated by the cross-hatched subframe 0) due to the transmission toggling of the mobile device 140. As a result, the mobile device 140 is unable to transmit the uplink transmission data 445 to the base station 120 during the allocated resource designated by the transmission grant 440. This results in another NACK 473 and another transmission grant 450 generated and provided to the mobile device 140. Again, the mobile device 140 will understand and expect a NACK to be transmitted by the base station 120 as the mobile device 140 is aware that it was unable to transmit the uplink transmission data 425.

In response to the transmission grant 450, the mobile device 140 can be configured to retransmit the uplink transmission to the base station 120. For example, the mobile device 140 can transmit uplink transmission data 455 to the base station 120. In this example, the mobile device 140 again has resources available to the second wireless network (as indicated by the solid, empty subframe 7) and transmits the uplink transmission data 455 to the base station 120. However, the uplink transmission data 455 was not successfully received as evidenced by the NACK 474 generated and transmitted to the mobile device 140.

At this point, the mobile device 140 has attempted four transmissions to the base station 120 during the HARQ procedure. Because the maximum number of transmissions has been reached (e.g., maximum HARQ retransmission threshold=4), the HARQ procedure will not perform another retransmission of the uplink transmission. Further, the mobile device 140 can be configured to flush one or more uplink HARQ buffers of the mobile device 140. In exemplary aspects where the mobile device 140 is configured to operate in a Radio Link Control (RLC) Unacknowledged Mode (UM), the mobile device 140 can be configured to store data to be retransmitted. The stored data can be retransmitted using the same RLC sequence number (SN) and a new uplink grant.

In operation, the Radio Link Control (RLC) of the base station 120 determines how the base station 120 handles unsuccessful HARQ retransmission procedures. For example, the RLC can operate in an Acknowledged Mode (AM) or an Unacknowledged Mode (UM).

As illustrated in FIG. 4, in an Acknowledged Mode, the RLC will generate an RLC status Protocol Data Unit (PDU) after a time (T_{elapsed}) following the HARQ transmission window. Further, the RLC of the base station 120 can transmit the status PDU to the mobile device 140. In response to the RLC status PDU, the mobile device 140 can initiate a schedule request (SR)/buffer status report (BSR) 475 for RLC-level retransmission or the mobile device 140 can retransmit at the RLC level. For example, if the uplink data is ongoing, the mobile device 140 can immediately retransmit at the RLC level if the grant size is sufficient or can initiate a BSR if the grant size is insufficient. If the uplink data is not ongoing, the mobile device 140 can initiate a SR. In an Unacknowledged Mode, the RLC will not generate the RLC status PDU and the unsuccessfully transmitted data will be dropped.

In an exemplary aspect, and with continued reference to FIG. 4, to reduce the delay between an unsuccessful HARQ procedure and a RLC-level retransmission, the mobile device 140 can be configured to initiate a preemptive scheduling request (SR)/buffer status report (BSR) procedure. For example, the mobile device 140 can be configured to initiate a SR/BSR (e.g., SR/BSR 460) in response to an unsuccessful HARQ retransmission procedure without receiving a RLC status PDU. In an exemplary aspect, the mobile device 140 can be configured to perform a BSR adjustment to adjust the BSR based on changes to the buffer status caused by the retransmission of data. The mobile device 140 can be configured to prioritize lost data over other data and retransmit the lost data with the same RLC sequence number (SN) using a new uplink grant.

Again, if the uplink data is ongoing, the mobile device 140 can immediately retransmit at the RLC level if the grant size is sufficient or can initiate a BSR if the grant size is insufficient. If the uplink data is not ongoing, the mobile device 140 can initiate a SR. In an exemplary aspect, the mobile device 140 can be configured to initiate the SR/BSR (e.g., SR/BSR 460) irrespective of the RLC mode. That is, the mobile device 140 can initiate the preemptive SR/BSR (e.g., SR/BSR 460) regardless of whether the RLC mode is an Acknowledged Mode (AM) or an Unacknowledged Mode (UM). Based on the schedule request 460, the base station 120 can generate and provide a transmission grant 462 to the mobile device 140. The mobile device 140 can be configured to transmit the uplink transmission to the base station 120 based on the transmission grant 462. For example, the mobile device 140 can transmit uplink transmission data 463 to the base station 120.

In this example, the mobile device 140 (e.g., controller 340) can be configured to determine the number of uplink transmissions actually being transmitted to the base station 120 based on the transmission toggling. For example, during the HARQ transmission window, two uplink transmissions (e.g., 435 and 455) were transmitted to the base station 120. The mobile device 140 was unable to transmit two uplink transmissions (e.g., 425 and 445) to the base station 120 because the transmission schedule was occupied by the first wireless network (as indicated by the cross-hatched subframes). That is, the mobile device 140 can determine the actual uplink transmissions to be two (e.g., Actual_UL_HARQ=2). The mobile device 140 can compare the actual uplink transmission value to the maximum HARQ retransmission threshold (e.g. 4), and based on this comparison, the mobile device 140 can initiate a preemptive SR/BSR (e.g., SR/BSR 460).

In an exemplary aspect, mobile device 140 can perform the preemptive retransmission procedure as long as the determined actual uplink transmissions are less than the maximum HARQ retransmission threshold.

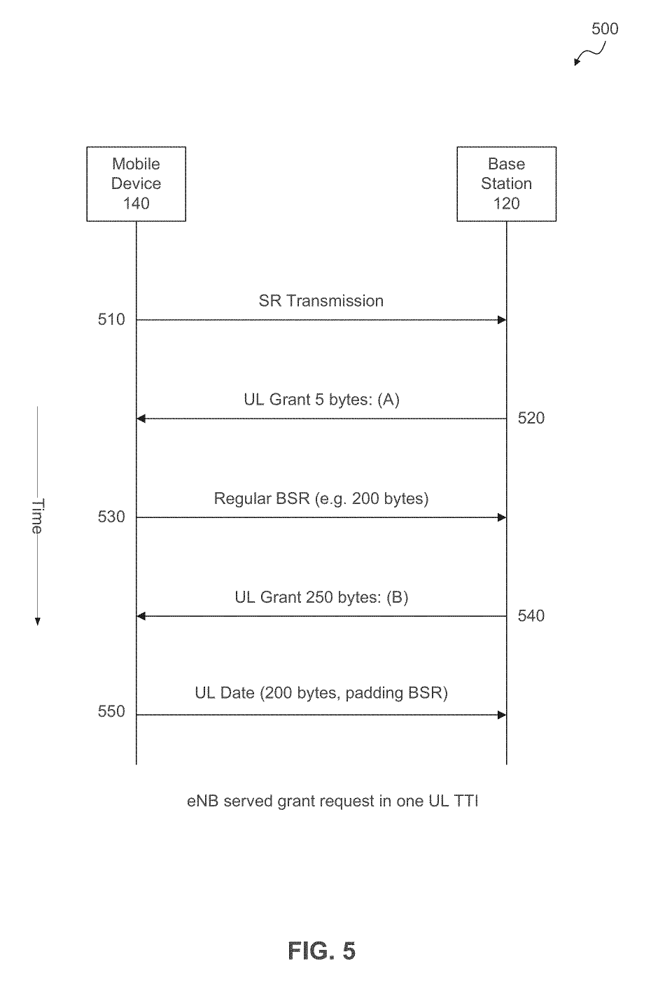

FIG. 5 illustrates a flowchart of scheduling request procedure 500 according to an exemplary aspect of the present disclosure. The flowchart is described with continued reference to FIGS. 1-4. The steps of the method are not limited to the order described below, and the various steps may be performed in a different order. Further, two or more steps of the method may be performed simultaneously with each other. The scheduling request procedure 500 can be an aspect of the scheduling request 408, 460, and/or 475 and subsequent grant and uplink data transmissions of FIG. 4.

The method of flowchart 500 begins at step 510, where the mobile device 140 generates a schedule request transmission and transmits the schedule request transmission to the base station 120.

After step 510, the flowchart 500 transitions to step 520, where, the base station 120 provides a first uplink grant to the mobile device 140 in response to the schedule request transmission. The first uplink grant can grant uplink resources of, for example, 5 bytes.

After step 520, the flowchart 500 transitions to step 530, where the mobile device 140 generates a buffer status report (BSR) and transmits the BSR to the base station 120. In an exemplary aspect, the BSR can be a regular BSR that indicates the amount of data the mobile device 140 intends to include in an uplink transmission. For example, the BSR can indicate that the mobile device 140 would like to transmit, for example, 200 bytes to the base station 120.

After step 530, the flowchart 500 transitions to step 540, where the base station 120 generates and provides an uplink grant to the mobile device 140. The uplink grant grants uplink resources to the mobile device 140 to transmit data to the base station 120. For example, the uplink grant can grant 250 bytes of resources to the mobile device 140.

After step 540, the flowchart 500 transitions to step 550, where the mobile device 140 generates uplink transmission data (e.g., uplink transmission data 415) and transmits the uplink transmission data to the base station 120. Because the base station 120 granted uplink resources of 250 bytes, the mobile device 140 can include a padding BSR with the uplink transmission data to fill out the allocated uplink resources.

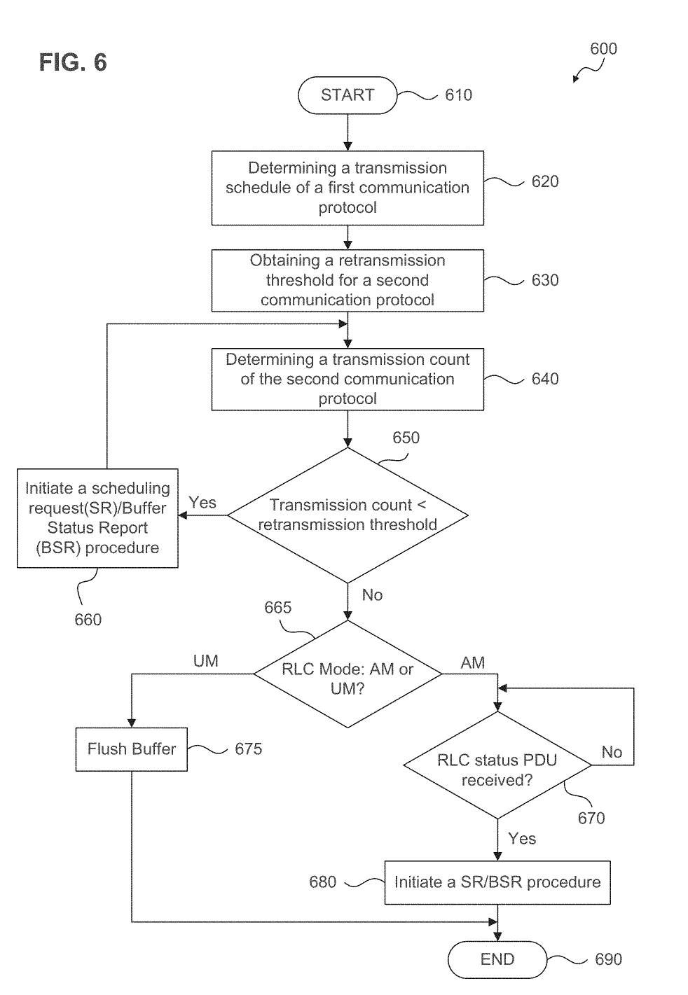

FIG. 6 illustrates a retransmission procedure 600 according to an exemplary aspect of the present disclosure. The flowchart is described with continued reference to FIGS. 1-5. The steps of the method are not limited to the order described below, and the various steps may be performed in a different order. Further, two or more steps of the method may be performed simultaneously with each other. The retransmission procedure 600 can be an aspect of the hybrid automatic repeat request (HARQ) procedure 400 illustrated in FIG. 4.

The method of flowchart 600 begins at step 610 and transitions to step 620, where a transmission schedule of a first communication protocol associated with a first wireless communication network is determined. In an exemplary aspect, the mobile device 140 can be configured to determine the transmission schedule. For example, the mobile device 140 can determine that during a Dual SIM-Dual active (DSDA) operation, some subframes (e.g., 406) will be used for transmission associated with a first wireless network (e.g., 2G), while other subframes (e.g., 404) will be used for transmission associated with a second wireless network (e.g., 2G/3G/4G).

After step 620, the method of flowchart 600 transitions to step 630, where a retransmission threshold is determined. In an exemplary aspect, the retransmission threshold is a maximum HARQ retransmission threshold (maxHARQTx). The mobile device 140 can be configured to determine the retransmission threshold. In one or more aspects, the retransmission threshold can be provided to the mobile device 140 by the base station 120. In an exemplary aspect, the maximum HARQ retransmission threshold (maxHARQTx) is four.

After step 630, the method of flowchart 600 transitions to step 640, where the number of uplink transmissions actually being transmitted (i.e., transmission count) to the base station 120 can be determined. The determination can be based on the transmission toggling between the first and second wireless communication networks by the mobile device 140. In this example, the mobile device 140 can determine which uplink transmission were actually transmitted to the base station 120 based on whether the transmitter 310 is being used by the other wireless communication network during the allocated resources.

For example, during the HARQ transmission window, two uplink transmissions (e.g., 435 and 455) were actually transmitted to the base station 120. The mobile device 140 was unable to transmit two uplink transmissions (e.g., 425 and 445) to the base station 120 because the transmission schedule was occupied by the first wireless network (as indicated by the cross-hatched subframes). That is, the mobile device 140 can determine the actual uplink transmissions to be two (e.g., Actual_UL_HARQ=2).

After step 640, the method of flowchart 600 transitions to step 650, where the actual transmission count can be compared to the retransmission threshold. If the transmission count is less than the retransmission threshold (YES at step 650), the flowchart 600 transitions to step 660. In an exemplary aspect, the mobile device 140 can prioritize lost data over other data and retransmit the lost data with the same RLC sequence number (SN) using a new uplink grant. In operation, and as discussed below at step 660, the SR/BSR (e.g., SR/BSR 460) can be immediately initiated as long as the actual transmission count is less than the retransmission threshold If the transmission count is not less than (e.g., equal to, or greater than) the retransmission threshold (NO at step 650), the flowchart 600 transitions to step 665.

For example, in FIG. 4, the actual uplink transmissions (Actual_UL_HARQ) is two, which is less than the maximum HARQ retransmission threshold (maxHARQTx) of four. In this case, the flowchart 600 would transition to step 660.

At step 660, a SR/BSR is initiated. In an exemplary aspect, the SR/BSR can be a scheduling request of a RLC-level retransmission procedure. The mobile device 140 can be configured to initiate the scheduling request. The SR/BSR can be, for example, a preemptive SR/BSR (e.g., SR/BSR 460 of FIG. 4), and can be initiated by the mobile device 140. In this example, the mobile device 140 does not wait to receive an RLC status Protocol Data Unit (PDU) before initiating the preemptive schedule request. That is, the mobile device 140 can be configured to initiate a SR/BSR irrespective/independent of receipt of an RLC status PDU and/or irrespective/independent of the RLC mode. In this example, the delay (e.g., T_{elapsed}) can be avoided or reduced. In an exemplary aspect, the mobile device 140 can be configured to store lost data only when the RLC mods is UM. The mobile device 140 can prioritize lost data over other data and retransmit the lost data with the same RLC sequence number (SN) using a new uplink grant independent of RLC mode. After step 660, the flowchart 600 returns to step 640, where the transmission count is again determined.

If the transmission count is not less than the retransmission threshold (NO at step 650), the flowchart 600 transitions to step 665, where the RLC mode is determined. For example, the mobile device 140 can be configured to determine whether the RLC mode is an RLC Acknowledged Mode (AM) or an RLC Unacknowledged Mode (UM).

If the RLC mode is an Acknowledged Mode (AM), the flowchart 600 transitions to step 670, where it is determined if an RLC status Protocol Data Unit (PDU) has been received. For example, the mobile device 140 waits until the RLC status PDU is received from the base station 120.

After step 670 (e.g., after the RLC status PDU is received) and if an RLC level NACK is received, the flowchart transitions to step 680, where a SR/BSR is initiated. In an exemplary aspect, the SR/BSR can be a SR/BSR of a RLC-level retransmission procedure. The mobile device 140 can be configured to initiate the SR/BSR.

If the RLC mode is an Unacknowledged Mode (UM) in step 665, the flowchart 600 transitions to step 675, where one or more uplink HARQ buffers can be flushed. For example, the mobile device 140 can be configured to flush the one or more uplink HARQ buffers of the mobile device 140. In an exemplary aspect, the uplink HARQ buffers can be flushed when the HARQ window has expired.

After steps 675 or 680, the flowchart 600 transitions to step 690, where the flowchart 600 ends. The flowchart 600 may be repeated one or more times. If repeated, the flowchart can begin at step 610 or another one of the steps 620 to 680.

### EXAMPLES

Example 1 is a communication method using a communication network, the method comprising: determining a transmission schedule of a first communication protocol; obtaining a retransmission threshold; identifying a transmission count of a second communication protocol based on the transmission schedule; comparing the transmission count to the retransmission threshold; and initiating a scheduling request or a buffer status report (BSR) based on the comparison.

In Example 2, the subject matter of Example 1, wherein the retransmission threshold is a maximum hybrid automatic repeat request (HARQ) retransmission threshold.

In Example 3, the subject matter of Example 1, wherein initiating the scheduling request or the BSR comprises: initiating the schedule request or the BSR independent of receipt of a status protocol data unit (PDU), and prioritizing lost data; and wherein the communication method further comprises: retransmitting the lost data using a same Radio Link Control (RLC) sequence number and a new uplink grant.

In Example 4, the subject matter of Example 1, wherein the transmission count is a number of successfully transmitted transmissions.

In Example 5, the subject matter of Example 4, wherein the transmissions are successfully transmitted hybrid automatic repeat request (HARQ) transmissions.

In Example 6, the subject matter of Example 1, further comprising: transmitting one or more communications using the second communication protocol based on the transmission schedule of the first communication protocol.

In Example 7, the subject matter of Example 6, wherein the transmission count is a number of successfully transmitted communications of the one or more communications using the second communication protocol.

In Example 8, the subject matter of Example 6, wherein the transmitting the one or more communications using the second communication protocol comprises transmitting the one or more communications during one or more inactive subframes of the transmission schedule of the first communication protocol.

In Example 9, the subject matter of Example 6, further comprising: receiving one or more negative acknowledgements from the communication network in response to the one or more transmitted communications, wherein the negative acknowledgments indicate unsuccessful receipt of respective ones of the one or more transmitted communications by the communication network.

In Example 10, the subject matter of Example 9, wherein the initiating the scheduling request or the BSR are further based on the receipt of the one or more negative acknowledgments.

In Example 11, the subject matter of Example 1, further comprising: storing data to be retransmitted; and retransmitting the stored data using a same Radio Link Control (RLC) sequence number (SN) and a new uplink grant.

Example 12 is a communication device configured to communicate using first and second communication protocols within a communication network, the communication device comprising: a transceiver configured to transmit one or more communications; and a controller configured to: determine a transmission schedule of the first communication protocol; obtain a retransmission threshold; identify a transmission count of the second communication protocol based on the transmission schedule; compare the transmission count to the retransmission threshold; and initiate a scheduling request or a buffer status report (BSR) based on the comparison.

In Example 13, the subject matter of Example 12, wherein the retransmission threshold is a maximum hybrid automatic repeat request (HARQ) retransmission threshold.

In Example 14, the subject matter of Example 12, wherein initiating the schedule request of the BSR comprises initiating the scheduling request or the BSR independent of receipt of a status protocol data unit (PDU) by the communication device.

In Example 15, the subject matter of Example 12, wherein the controller is further configured to: control the transceiver to transmit the one or more communications using the second communication protocol based on the transmission schedule of the first communication device.

In Example 16, the subject matter of Example 15, wherein the transmission count is a number of successfully transmitted communications of the one or more communications by the transceiver.

In Example 17, the subject matter of Example 12, wherein the transmission count is a number of successfully transmitted communications of the one or more communications by the transceiver.

In Example 18, the subject matter of Example 17, wherein the transmissions of the one or more communications are successfully transmitted hybrid automatic repeat request (HARQ) transmissions by the communication device.

In Example 19, the subject matter of Example 15, wherein the transmitting the one or more communications using the second communication protocol comprises transmitting the one or more communications during one or more inactive subframes of the transmission schedule of the first communication protocol.

In Example 20, the subject matter of Example 15, wherein the transceiver is further configured to: receive one or more negative acknowledgements via the communication network in response to the one or more transmitted communications, wherein the negative acknowledgments indicate unsuccessful receipt of respective ones of the one or more transmitted communications by another communication device.

In Example 21, the subject matter of Example 20, wherein the controller is further configured to initiate the scheduling request or the BSR based on the receipt of the one or more negative acknowledgments.

In Example 22, the subject matter of Example 20, wherein the controller is further configured to: identify one or more other negative acknowledgements based on the transmission schedule of the first communication protocol.

In Example 23, the subject matter of Example 21, wherein the controller is further configured to: adjust the BSR based on changes to the buffer status.

Example 24 is a communication method using a communication network, the method comprising: determining a transmission schedule of a first communication protocol; obtaining a retransmission threshold associated with a second communication protocol; identifying a transmission count of the second communication protocol based on the transmission schedule, the transmission count being a number of transmissions that have been successfully transmitted; comparing the transmission count to the retransmission threshold; and initiating a scheduling request or a buffer status report (BSR) based on the comparison, wherein the scheduling request or the BSR are initiated before receipt of a status protocol data unit.

In Example 25, the subject matter of Example 24, wherein initiating the scheduling request or the BSR comprises prioritizing lost data, and wherein the communication method further comprises retransmitting the lost data using a same Radio Link Control (RLC) sequence number and a new uplink grant irrespective of the RLC mode.

In Example 26, the subject matter of any of Examples 1-6, wherein the transmission count is a number of successfully transmitted transmissions.

In Example 27, the subject matter of any of Examples 1-7, wherein the retransmission threshold is a maximum hybrid automatic repeat request (HARQ) retransmission threshold.

In Example 28, the subject matter of any of Examples 1-8, wherein initiating the scheduling request or the BSR comprises initiating the scheduling request or BSR independent of receipt of a status protocol data unit (PDU).

In Example 29, the subject matter of any of Examples 1-9, further comprising: storing data to be retransmitted; and retransmitting the stored data using a same Radio Link Control (RLC) sequence number (SN) and a new uplink grant.

Example 30 is an apparatus comprising means to perform the subject matter of any of Examples 1-6 and 24-29.

Example 31 is machine-readable storage including machine-readable instructions, when executed, to implement or realize the subject matter of any of Examples 1-6 and 25-29.

Example 32 is a communication device configured to communicate using first and second communication protocols within a communication network, the communication device comprising: transceiving means for transmitting one or more communications; and controlling means for: determining a transmission schedule of the first communication protocol; obtaining a retransmission threshold; identifying a transmission count of the second communication protocol based on the transmission schedule; comparing the transmission count to the retransmission threshold; and initiating a scheduling request or a buffer status report (BSR) based on the comparison.

In Example 33, the subject matter of Example 32, wherein the retransmission threshold is a maximum hybrid automatic repeat request (HARQ) retransmission threshold.

In Example 34, the subject matter of Example 32, wherein the transmission count is a number of successfully transmitted communications of the one or more communications by the transceiver.

In Example 35, the subject matter of any of Examples 1-4, further comprising: transmitting one or more communications using the second communication protocol based on the transmission schedule of the first communication protocol.

In Example 36, the subject matter of any of Examples 12-14, wherein the controller is further configured to: control the transceiver to transmit the one or more communications using the second communication protocol based on the transmission schedule of the first communication device.

In Example 37, the subject matter of Example 36, wherein the transmission count is a number of successfully transmitted communications of the one or more communications by the transceiver.

In Example 38, the subject matter of any of Examples 12-14, wherein the transmission count is a number of successfully transmitted communications of the one or more communications by the transceiver.

In Example 39, the subject matter of Example 38, wherein the transmissions of the one or more communications are successfully transmitted hybrid automatic repeat request (HARQ) transmissions by the communication device.

### CONCLUSION

The aforementioned description of the specific aspects will so fully reveal the general nature of the disclosure that others can, by applying knowledge within the skill of the art, readily modify and/or adapt for various applications such specific aspects, without undue experimentation, and without departing from the general concept of the present disclosure. Therefore, such adaptations and modifications are intended to be within the meaning and range of equivalents of the disclosed aspects, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

References in the specification to “one aspect,” “an aspect,” “an exemplary aspect,” etc., indicate that the aspect described may include a particular feature, structure, or characteristic, but every aspect may not necessarily include the particular feature, structure, or characteristic. Moreover, such phrases are not necessarily referring to the same aspect. Further, when a particular feature, structure, or characteristic is described in connection with an aspect, it is submitted that it is within the knowledge of one skilled in the art to affect such feature, structure, or characteristic in connection with other aspects whether or not explicitly described.

The exemplary aspects described herein are provided for illustrative purposes, and are not limiting. Other exemplary aspects are possible, and modifications may be made to the exemplary aspects. Therefore, the specification is not meant to limit the disclosure. Rather, the scope of the disclosure is defined only in accordance with the following claims and their equivalents.

Aspects may be implemented in hardware (e.g., circuits), firmware, software, or any combination thereof. Aspects may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact results from computing devices, processors, controllers, or other devices executing the firmware, software, routines, instructions, etc. Further, any of the implementation variations may be carried out by a general purpose computer.

For the purposes of this discussion, the term “processor circuitry” shall be understood to be circuit(s), processor(s), logic, or a combination thereof. For example, a circuit can include an analog circuit, a digital circuit, state machine logic, other structural electronic hardware, or a combination thereof. A processor can include a microprocessor, a digital signal processor (DSP), or other hardware processor. The processor can be “hard-coded” with instructions to perform corresponding function(s) according to aspects described herein. Alternatively, the processor can access an internal and/or external memory to retrieve instructions stored in the memory, which when executed by the processor, perform the corresponding function(s) associated with the processor, and/or one or more functions and/or operations related to the operation of a component having the processor included therein.

In one or more of the exemplary aspects described herein, processor circuitry can include memory that stores data and/or instructions. The memory can be any well-known volatile and/or non-volatile memory, including, for example, read-only memory (ROM), random access memory (RAM), flash memory, a magnetic storage media, an optical disc, erasable programmable read only memory (EPROM), and programmable read only memory (PROM). The memory can be non-removable, removable, or a combination of both.

As will be apparent to a person of ordinary skill in the art based on the teachings herein, exemplary aspects are not limited to the Long-Term Evolution (LTE) and/or LTE Advanced standards, and can be applied to other cellular communication standards, including (but not limited to) Evolved High-Speed Packet Access (HSPA+), Wideband Code Division Multiple Access (W-CDMA), CDMA2000, Time Division-Synchronous Code Division Multiple Access (TD-SCDMA), Global System for Mobile Communications (GSM), General Packet Radio Service (GPRS), Enhanced Data Rates for GSM Evolution (EDGE), and Worldwide Interoperability for Microwave Access (WiMAX) (IEEE 802.16) to provide some examples. Further, exemplary aspects are not limited to cellular communication networks and can be used or implemented in other kinds of wireless communication access networks, including (but not limited to) Wi-Fi (IEEE 802.11), Bluetooth, Near-field Communication (NFC) (ISO/IEC 18092), ZigBee (IEEE 802.15.4), and/or Radio-frequency identification (RFID), to provide some examples. Further, exemplary aspects are not limited to the above wireless networks and can be used or implemented in one or more wired networks using one or more well-known wired specifications and/or protocols.

What is claimed is:

1. A communication method using a communication network, the method comprising:
determining a transmission schedule of a first communication protocol;
obtaining a retransmission threshold;
identifying a transmission count of a second communication protocol based on the transmission schedule;
comparing the transmission count to the retransmission threshold; and
initiating a scheduling request or a buffer status report (BSR) based on the comparison.

2. The communication method of claim 1, wherein the retransmission threshold is a maximum hybrid automatic repeat request (HARQ) retransmission threshold.

3. The communication method of claim 1,
wherein initiating the scheduling request or the BSR comprises:
initiating the scheduling request or the BSR independent of receipt of a status protocol data unit (PDU), and
prioritizing lost data; and
wherein the communication method further comprises: retransmitting the lost data using a same Radio Link Control (RLC) sequence number and a new uplink grant.

4. The communication method of claim 1, wherein the transmission count is a number of successfully transmitted transmissions.

5. The communication method of claim 4, wherein the transmissions are successfully transmitted hybrid automatic repeat request (HARQ) transmissions.

6. The communication method of claim 1, further comprising: transmitting one or more communications using the second communication protocol based on the transmission schedule of the first communication protocol.

7. The communication method of claim 6, wherein the transmission count is a number of successfully transmitted communications of the one or more communications using the second communication protocol.

8. The communication method of claim 6, wherein the transmitting the one or more communications using the second communication protocol comprises transmitting the one or more communications during one or more inactive subframes of the transmission schedule of the first communication protocol.

9. The communication method of claim 6, further comprising:
receiving one or more negative acknowledgements from the communication network in response to the one or more transmitted communications, wherein the negative acknowledgments indicate unsuccessful receipt of respective ones of the one or more transmitted communications by the communication network.

10. The communication method of claim 9, wherein the initiating the scheduling request or the BSR are further based on the receipt of the one or more negative acknowledgments.

11. The communication method of claim 1, further comprising:
storing data to be retransmitted; and
retransmitting the stored data using a same Radio Link Control (RLC) sequence number (SN) and a new uplink grant.

12. A communication device configured to communicate using first and second communication protocols within a communication network, the communication device comprising:
a transceiver configured to transmit one or more communications; and
a controller configured to:
determine a transmission schedule of the first communication protocol;
obtain a retransmission threshold;
identify a transmission count of the second communication protocol based on the transmission schedule;
compare the transmission count to the retransmission threshold; and
initiate a scheduling request or a buffer status report (BSR) based on the comparison.

13. The communication device of claim 12, wherein the retransmission threshold is a maximum hybrid automatic repeat request (HARQ) retransmission threshold.

14. The communication device of claim 12, wherein initiating the scheduling request or the BSR comprises initiating the scheduling request or the BSR independent of receipt of a status protocol data unit (PDU) by the communication device.

15. The communication device of claim 12, wherein the controller is further configured to:
control the transceiver to transmit the one or more communications using the second communication protocol based on the transmission schedule of the first communication device.

16. The communication device of claim 15, wherein the transmission count is a number of successfully transmitted communications of the one or more communications by the transceiver.

17. The communication device of claim 12, wherein the transmission count is a number of successfully transmitted communications of the one or more communications by the transceiver.

18. The communication device of claim 17, wherein the transmissions of the one or more communications are successfully transmitted hybrid automatic repeat request (HARQ) transmissions by the communication device.

19. The communication device of claim 15, wherein the transmitting the one or more communications using the second communication protocol comprises transmitting the one or more communications during one or more inactive subframes of the transmission schedule of the first communication protocol.

20. The communication device of claim 15, wherein the transceiver is further configured to:
receive one or more negative acknowledgements via the communication network in response to the one or more transmitted communications, wherein the negative acknowledgments indicate unsuccessful receipt of respective ones of the one or more transmitted communications by another communication device.

21. The communication device of claim 20, wherein the controller is further configured to initiate the scheduling request or the BSR based on the receipt of the one or more negative acknowledgments.

22. The communication device of claim 20, wherein the controller is further configured to:
identify one or more other negative acknowledgements based on the transmission schedule of the first communication protocol.

23. The communication device of claim 21, wherein the controller is further configured to: adjust the BSR based on changes to the buffer status.

24. A communication method using a communication network, the method comprising:
determining a transmission schedule of a first communication protocol;
obtaining a retransmission threshold associated with a second communication protocol;
identifying a transmission count of the second communication protocol based on the transmission schedule, the transmission count being a number of transmissions that have been successfully transmitted;
comparing the transmission count to the retransmission threshold; and
initiating a scheduling request or a buffer status report (BSR) based on the comparison, wherein the scheduling request or the BSR are initiated before receipt of a status protocol data unit.

25. The communication method of claim 24, wherein initiating the scheduling request or the BSR comprises prioritizing lost data, and wherein the communication method further comprises retransmitting the lost data using a same Radio Link Control (RLC) sequence number and a new uplink grant irrespective of the RLC mode.
